(19) United States
(12) Patent Application Publication
(10) Pub. No.: US 2004/0096712 A1
(43) Pub. Date: May 20, 2004

(54) Method for reusing fuel

(76) Inventor: Judd McManus, Higganum, CT (US)

Correspondence Address: Judd McManus, 280 Hidden Lake Rd, Higganum, CT, 06441, US

(21) Appl. No.: 10/294,195

(22) Filed: Nov. 15, 2002

(51) Int. Cl. H01M 8/04

(52) U.S. Cl. 429/17

(57) ABSTRACT

A method for reusing fuel is presented. This invention also relates to the reuse of fuel in the context of fuel cell systems.

The benefits of reusing fuel are enormous. With the ability to reuse fuel the growing demands for energy can now be met with an environmentally safe, affordable, and practical technology.

Through the invented method, fuel can now be reused while producing a wide range of electrical outputs using a practical, safe, and low-cost method. By following the steps of the invented method we can now reuse fuel in fuel cell systems.

### CROSS-REFERENCE TO RELATED APPLICATIONS

Application Ser. No. 10/157,675 filed on May 29, 2002 Application Ser. No. 10/198,661 filed on Jul. 16, 2002

### STATEMENT REGARDING FEDERALLY SPONSORED RESEARCH

Not Applicable

### REFERENCE TO A MICROFICHE APPENDIX

Not Applicable

### BACKGROUND OF THE INVENTION

This invention relates to the reuse of fuel. This invention also relates to the reuse of fuel in the context of fuel cell systems.

The benefits of reusing fuel are enormous. With the ability to reuse fuel the growing demands for energy can now be met with an environmentally safe, affordable, and practical technology.

In one of my earlier patent applications (Ser. No. 10/157,675 filed on May 29, 2002) I demonstrate a method for transferring hydrogen gas in PEM fuel cell systems and assembling hydrogen atoms. In application (Ser. No. 10/157,675) I illustrate the ability to capture the hydrogen gas in a storage container after using it through the PEM fuel cell system. In application (Ser. No. 10/198,661) I show the techniques for recycling the hydrogen rather than storing it. With this invention, I have now developed a new technique for using and reusing hydrogen fuel while being coupled with a standard hydrogen/oxygen fuel cell system in order to achieve a wide range of electrical outputs quickly and easily.

Accordingly, it is an object of this invention to provide a new method for reusing fuel. Furthermore, it is an object of this invention to provide for the key series of steps needed to reuse fuel in a fuel cell system.

Through the invented method, fuel can now be reused while producing a wide range of electrical outputs using a practical, safe, and low-cost method. By following the steps of the invented method we can now reuse fuel in fuel cell systems.

### BRIEF SUMMARY OF THE INVENTION

The invented method for reusing fuel is configured to include hydrogen gas, two fuel cell systems, transport piping, pressure, and oxygen.

The transport piping is filled with hydrogen gas on one side and oxygen on the other. Hydrogen gas is supplied to one side of the fuel cell system using pressure, while oxygen is supplied to one side of the other fuel cell system using pressure.

As hydrogen molecules come into contact with the platinum coating on the proton conductive membrane of the first fuel cell system, molecules separate into single atoms. The membrane assists in separating the hydrogen atoms into protons and electrons by allowing the protons to pass through the membrane and blocking the electrons. Sufficient pressure is used to assist in forcing the protons through the membrane.

Electrons are able to travel through an external electrical circuit where they can be used to perform work. The protons and free electrons end up on the same side of the membrane. The configuration of the transport piping between the first and second fuel cell system provides proper conditions to prevent the protons and free electrons from reacting with any other substance; the protons and free electrons are now able to combine to form hydrogen atoms. The configuration of the transport piping provides proper conditions to prevent the hydrogen atoms from reacting with any other substance; the hydrogen atoms are now able to form hydrogen molecules.

As the hydrogen molecules come into contact with the platinum coating on the proton conductive membrane of the second fuel cell system, molecules separate into single atoms. The membrane assists in separating the hydrogen atoms into protons and electrons by allowing the protons to pass through the membrane and blocking the electrons.

Electrons are able to travel through an external electrical circuit where they can be used to perform work. The protons and free electrons end up on the same side of the membrane, this time with oxygen also present.

The protons, free electrons, and oxygen react to form water, which is then taken away from the fuel cell system via transport piping.

By following the steps of the invented method we are now able to use fuel for a useful purpose, reuse the fuel, and combine free electrons and constituent parts with an additional substance to form a new substance.

### BRIEF DESCRIPTION OF DRAWING

FIG. 1—Sample configuration to perform the invented method

### DETAILED DESCRIPTION OF THE INVENTION

The invented method for reusing fuel is configured to include hydrogen gas, pressure, transport piping, two fuel cell systems, and oxygen.

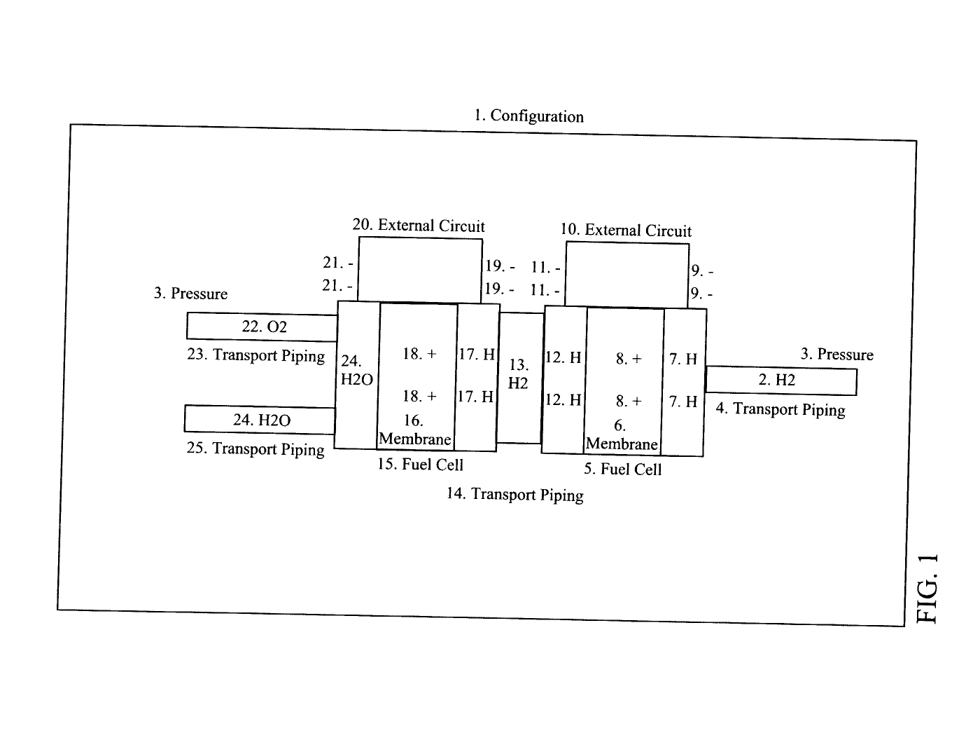

FIG. 1 shows a sample configuration (1) containing hydrogen gas (2), pressure (3), transport piping (4/14/23/25), two fuel cell systems (5/15), and oxygen (22).

To replicate the invented method we set up the configuration (1) as shown in FIG. 1.

The transport piping (4/23) is filled with hydrogen gas (2) on one side (4) and oxygen (22) on the other (23). Hydrogen gas (2) is supplied to one side of the fuel cell system (5) using pressure (3), while oxygen (22) is supplied to one side of the other fuel cell system (15) using pressure (3).

As hydrogen gas/molecules (2) come into contact with the platinum coating on the proton conductive membrane (6) of the first fuel cell system (5), molecules (2) separate into single atoms (7). The membrane (6) assists in separating the hydrogen atoms (7) into protons (8) and electrons (9) by allowing the protons (8) to pass through the membrane (6) and blocking the electrons (9). Sufficient pressure (3) is used to assist in forcing the protons (8) through the membrane (6).

Electrons (9) are able to travel through an external electrical circuit (10) where they can be used to perform work. The protons (8) and free electrons (11) end up on the same side of the membrane. The configuration of the transport piping (14) between the first (5) and second fuel cell system (15) provides proper conditions to prevent the protons (8) and free electrons (11) from reacting with any other substance; the protons (8) and free electrons (11) are now able to combine to form hydrogen atoms (12). The configuration of the transport piping (14) provides proper conditions to prevent the hydrogen atoms (12) from reacting with any other substance; the hydrogen atoms (12) are now able to form hydrogen molecules (13).

As the hydrogen molecules (13) come into contact with the platinum coating on the proton conductive membrane (16) of the second fuel cell system (15), molecules (13) separate into single atoms (17). The membrane (16) assists in separating the hydrogen atoms (17) into protons (18) and electrons (19) by allowing the protons (18) to pass through the membrane (16) and blocking the electrons (19).

Electrons (19) are able to travel through an external electrical circuit (20) where they can be used to perform work. The protons (18) and free electrons (21) end up on the same side of the membrane (16), this time with oxygen (22) also present.

The protons (18), free electrons (21), and oxygen (22) react to form water (24), which is then taken away from the fuel cell system (15) via transport piping (25).

By following the steps of the invented method and setting up the configuration (1) as shown in FIG. 1, we are now able to use fuel (2) for a useful purpose, reuse the fuel (13), and combine free electrons (21) and constituent parts (18) with an additional substance (22) to form a new substance (24).

Although the above description contains many specifics, these should not be construed as limiting the scope of the invention, but as providing illustrations of some of the presently preferred embodiments of this invention.

Thus the scope of the invention should be determined by the appended claims and their legal equivalents, rather than by the example given.

I claim:

1. Method for reusing fuel, comprising fuel, separating said fuel into constituent parts, free electrons traveling through external circuit, free electrons and constituent parts combining to form said fuel, repeating previous steps as many times as desired, separating said fuel into constituent parts, free electrons traveling through external circuit, free electrons, constituent parts, and additional substance combining to form new substance whereby fuel can be used for a useful purpose, reused one of more times, and combined with another substance to form a new substance.

2. Method for reusing fuel, comprising the steps of claim 1 where fuel is hydrogen.

3. Method for reusing fuel, comprising the steps of claim 1 where additional substance contains oxygen.

4. Method for reusing fuel, comprising the steps of claim 1 where new substance is water.

5. Method for reusing fuel, comprising the steps of claim 1 where any heat generated is used for a useful purpose.
